(19) United States
(12) Patent Application Publication
(10) Pub. No.: US 2011/0020083 A1
(43) Pub. Date: Jan. 27, 2011

(54) REAMER

(75) Inventor: Heinz Gauggel, Winterlingen (DE)

Correspondence Address: HARNESS, DICKEY & PIERCE, P.L.C., P.O. BOX 828, BLOOMFIELD HILLS, MI, 48303, US

(73) Assignee: MAPAL FABRIK FUR PRAZISIONSWERZEUGE DR. KRESS KG, Aalen (DE)

(21) Appl. No.: 12/933,809

(22) PCT Filed: Jul. 23, 2009
(86) PCT No.: PCT/EP09/05357

§ 371 Date: Sep. 21, 2010

(30) Foreign Application Priority Data
Aug. 21, 2008 (DE) 10 2008 045 327.7

(51) Int. Cl. B23D 77/00

(52) U.S. Cl. 408/60

(57) ABSTRACT

A reamer (1) is proposed that comprises
a main body (3),
   that has a first end face (5),
   in the peripheral face (7) of which grooves (11) are inserted, and
   that has an inner coolant/lubricant supply including channels (17) which intersect the peripheral face (7) of the main body (3) and thus form outlet orifices (15), and also comprises
blades (9) insertable into the grooves (11), wherein
the outlet orifices (15) are disposed at a distance from the end face (5) of the main body (3),
   said reamer being characterized in that
a flow channel (19) is created between each two adjacent blades (9, 9′) that is delimited by facing lateral surfaces (21, 31) of the blades (9, 9′) and the peripheral face (7) of the main body (3), the peripheral face being intact between outlet orifices (15) and the end face (5) of the main body (3).

The invention relates to a reamer as set forth in the preamble of claim 1.

Reamers of the type referenced here are well known (DE 10 2006 043 616 A1). They have a main body including an end face and a peripheral face into which grooves are incorporated. They furthermore include an inner coolant/lubricant supply with channels that interrupt the peripheral face of the main body. Blades are inserted in the grooves by which the swarf can be removed from a drilling surface by generating a relative rotation between the tool and a workpiece being machined—generally, by an introducing the rotating reamer into the drilled hole of a stationary workpiece. The resulting swarf is accommodated by the swarf spaces that are created by indentations in the main body that are disposed between the blades. The outlet orifices of the channels are situated a certain distance from the end face of the main body. As the reamer is introduced into a drilled hole, the coolant/lubricant flows out of the outlet orifices, cools the blades and the tool being worked, and effects the removal of the swarf created when the tool is worked. It has been determined that especially effective working results occur when the reamer is provided with very many blades, each of which has cutting edges that engage the drilling surface of a workpiece and remove the swarf. It has been found that the main body of the reamer is significantly weakened, particularly in the case of small diameters, by a large number of blades and associated swarf spaces, with the result that the tool does not have adequate strength, and this results in a failure of the tool, and also, in particular, in a reduction in the surface quality of the drilled hole being worked. In addition, adequate cooling and/or lubrication of the reamer is not always assured.

The object of the invention is thus to create a reamer of such design that these disadvantages can be prevented.

To achieve this object, a reamer is proposed that has the features referenced in claim 1. Inserted in its peripheral face are blades including geometrically defined cutting edges that function to machine the workpiece. A flow channel is created circumferentially between each two adjacent blades, the channel being laterally delimited by the mutually facing lateral surfaces of the blades. The peripheral face of the main body of the reamer also functions to delimit this flow channel. When the reamer is introduced into a drilled hole of a workpiece, its inner surface delimits the flow channel externally. A characterizing aspect of the reamer proposed here is the fact that its peripheral face between the outlet orifices and the end face of the main body is intact. The design of the reamer provided here is characterized in that the peripheral face, that is, in the region of the flow channel, does not include any special indentations, such as those provided to create conventional swarf spaces in the circumferential surface of the reamer. As a result, a defined flow channel for the coolant/lubricant is produced between the outlet orifices and the end face of the main body, which channel is distinguished by high flow rates and a large volumetric flow rate, thereby providing an intensive cooling or lubrication of the reamer. Due to the fact that indentations are eliminated in the peripheral face of the reamer, its main body is very strong even when the number of blades inserted in the peripheral face is quite large relative to the size of the circumferential surface or to the diameter of the reamer. It is found here that the concept of “intact” is very much compatible with the idea that the peripheral face of the reamer includes machining marks, or, for example, flow guide means, for example, in the form of flutes or protrusions.

A reamer is especially preferred that is distinguished by the fact that the channels functioning to supply coolant/lubricant run at an angle and are arranged such that their central axis, at least in the region of the peripheral face of the main body of the reamer, comprises an angle with the rotational or central axis of the reamer such that they are inclined relative to the end face of the reamer. Coolant/lubricant exiting from the channels thus emerges obliquely forward towards the end face, and thus in the feed direction, when the reamer is used to work the drilled hole. The result is that the swarf is removed especially effectively forwards from the flow channel, in particular, if the circumferential surface of the reamer is intact and thus no cross-sectional enlargements are created, as this would result in a reduction in the flow rate of the coolant/lubricant, and thus in a reduced effectiveness in terms of the swarf removal. Cooling of the reamer, in particular, of the active cutting edges and of the tool, would also not be as effective.

Additional developments are revealed in the subordinate claims.

The following discussion describes the invention in more detail based on the drawing. In the drawing:

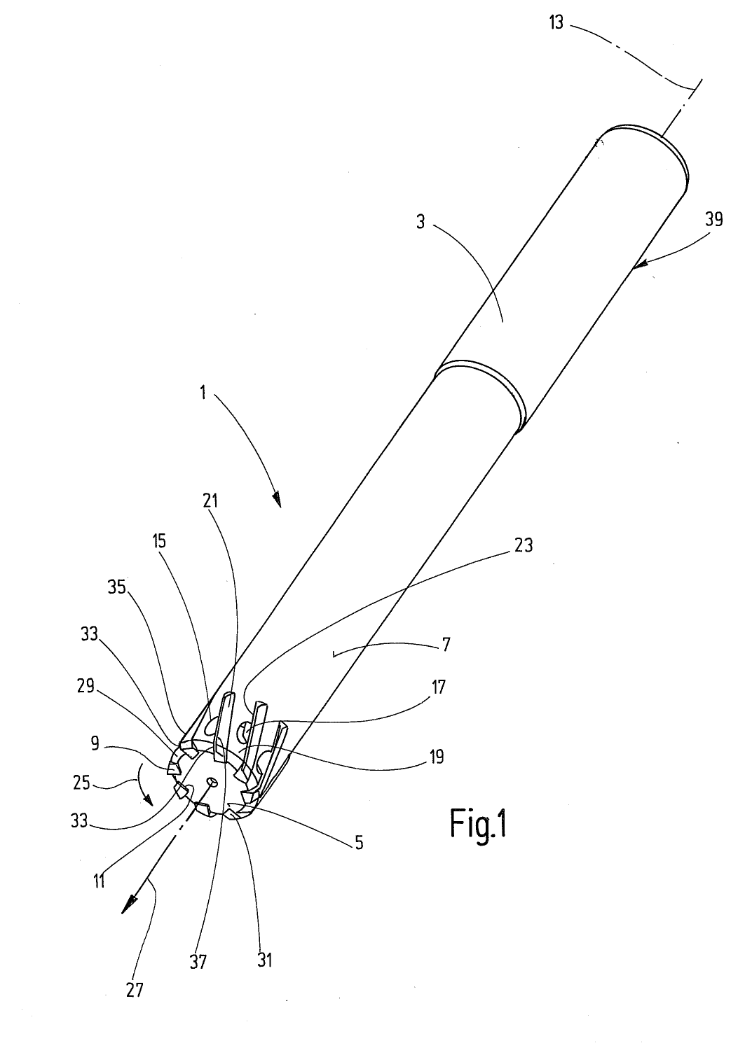

FIG. 1 is a perspective front view of a reamer including blades inserted in its main body;

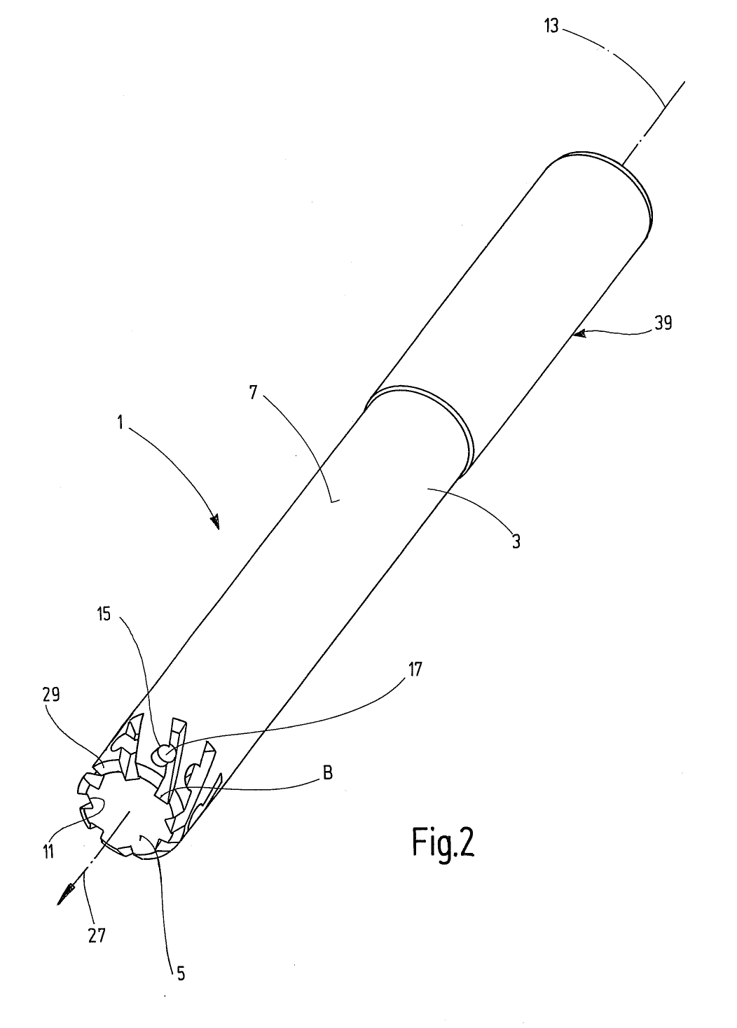

FIG. 2 illustrates the reamer of FIG. 1 without blades; and

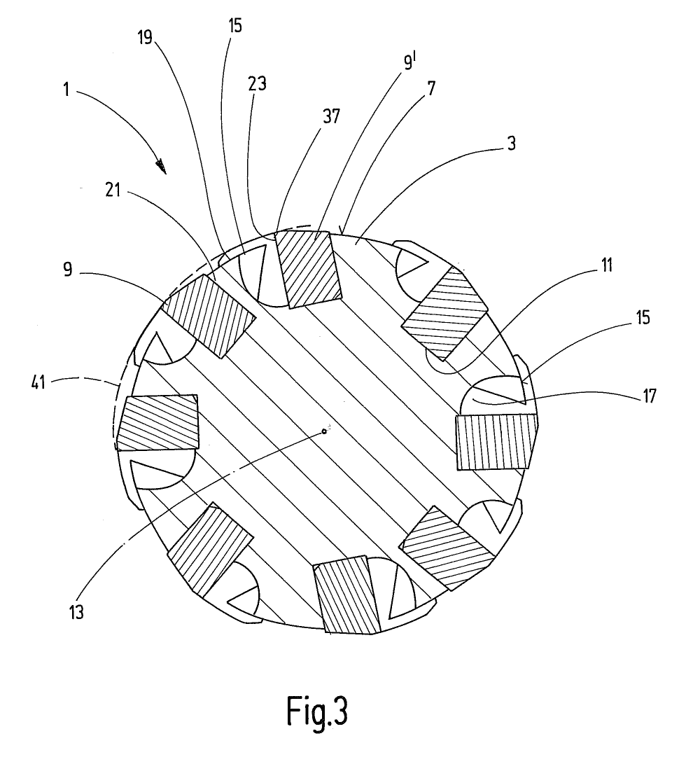

FIG. 3 illustrates a cross-section through the reamer of FIGS. 1 and 2 in the region of outlet orifices for a coolant/lubricant.

FIG. 1 illustrates a reamer 1 including a main body 3 that has an end face 5 and a peripheral face 7 surrounding the end face. The peripheral face includes a number of blades 9 that are inserted in the grooves 11 incorporated in peripheral face 7 of reamer 1. The depth of grooves 11 and the width of blades 9, as measured radially relative to the rotational or central axis 13 of reamer 1, are matched to each other such that the external longitudinal edges with the active cutting edges of blades 9 protrude beyond circumferential surface 7. The external longitudinal sides of blades 9 protrude—preferably, irrespective of the diameter of reamer 1-0.2 mm to 0.5 mm beyond peripheral face 7 of main body 3. A protrusion of 0.3 mm to 0.4 mm is especially preferred. The width of grooves 11 and the thickness of blades 9 are selected such that a press fit is created when blades 9 are inserted into main body 3 of reamer 1. Blades 9 can be secured in place by gluing or by soldering them in main body 3, where the adhesive or solder should be provided, in particular, at the base of groove 11, thereby fastening each blade 9 by its interior longitudinal side within main body 3.

Outlet orifices 15 are evident in peripheral face 7 between two adjacent blades at a distance from end face 5, in which openings channels 17 of a coolant/lubricant supply provided inside main body 3 open. Through these outlet orifices 15, a coolant/lubricant introduced into main body 3 of reamer 1 can thus emerge through peripheral face 7.

A flow channel 19 is created between each of two adjacent blades 9 for the coolant/lubricant. Flow channel 19 is delimited laterally by the facing lateral surfaces 21, 23 of the adjacent blades, additionally by peripheral face 7 of main body 3. The swarf removed by geometrically defined cutting edges of the blades is diverted forwards by the coolant/lubricant flowing through flow channel 19. When working a surface of a drilled hole, the embodiment of reamer 1 shown here rotates, as indicated by the arrow 25, counterclockwise and is advanced axially forwards, thereby producing the feed direction indicated by an arrow 27. This means, in other words, that the swarf is diverted in the feed direction and carried away. Provision is made in reamer 1 whereby an outlet orifice 15 is provided between each two adjacent blades 9. Each flow channel 19 that is provided between each two adjacent blades 9 thus has its own outlet orifice 15.

It is evident in the diagram of FIG. 1 that end face 5 has a bevel 29, with the result that end face 5 thus includes two regions: a first region, which is disposed about central axis 13, lies in a plane, relative to which central axis 13 is perpendicular. A second region of end face 5 is formed by bevel 29 that slopes away starting from the first region towards peripheral face 7, thereby essentially creating a frustoconical circumferential surface.

FIG. 1 also shows that peripheral face 7 of main body 3, which face surrounds end face 5 with bevel 29, is intact between outlet orifice 15, and end face 5 or bevel 29. This region of peripheral face 7 that delimits flow channel 19 thus does not have any indentations to create a swarf space, such as those provided in conventional reamers 1. The consequence of this is as follows:

During the working of a drilled hole by reamer 1, a flow channel 19 is delimited by lateral surfaces 21 and 23 of adjacent blades 9, also by the inner wall of the worked drilled hole. The inner delimiting surface of flow channel 19 facing central axis 13 is thus created by the intact region of peripheral face 7 that is situated between outlet orifice 15 and end face 5. Due to the fact that no indentations of the conventional type are provided between outlet orifice 15 and end face 5, a flow cross-section is created for the cooling/lubricating medium exiting from associated outlet orifice 15. An existing, preferably high, flow-through rate and high volumetric flow are thus maintained, in other words, with a uniform flow cross-section, up to end face 5 of reamer 1, thereby resulting in optimum cooling or lubrication of reamer 1, while at the same time the removed swarf is diverted very effectively. Provision is preferably made here whereby the flow cross-section of flow channel 19 decreases towards end face 5—in particular, continuously. This results in an increase in the flow-through rate, that is, the rate of flow by the coolant/lubricant in the area of flow channel 19.

This approach ensures that main body 3 of reamer 1 is not weakened by any indentations in peripheral face 7. As a result, it is possible to insert a large number of blades 9 in adjacent fashion into main body 3—in particular, in such cases where reamer 1 involves very small diameters.

The statement that peripheral face 7 is intact in the area between outlet orifice 15 and end face 5 should not be construed to mean that no sort of machining traces or the like are present in this area, which could be generated by producing reamer 1, for example, by turning or grinding main body 3. The term “intact” is also not intended to exclude the possibility that flow guiding devices are provided in this area of peripheral face 7—for example, flutes or ridges that function to affect the flow path of coolant/lubricant flowing within flow channel 19. Provision can be made whereby these kinds of flow guide means are created parallel to central axis 13, or at an angle thereto, such that the coolant/lubricant exiting from outlet orifice 15 is directed against lateral surface 23 of associated blade 9. It is also possible to implement coatings or the like so as to optimize the flow behavior of the coolant/lubricant within flow channel 19, in particular, also by means of the so-called shark-skin effect.

FIG. 1 shows that outlet orifice 15 is not situated at the center between two adjacent blades 9 but instead immediately borders on one of the two blades. What is involved here is a trailing blade, as viewed in the direction of rotation indicated by arrow 25, which delimits outlet orifice 15. This blade 9 is cooled especially well by this factor alone. If the coolant/lubricant flow is additionally passed through flow guide means against lateral surface 23 of blade 9, the result is an especially effective cooling and lubrication of the active cutting edges of this blade.

As is evident in FIG. 1, blades 9 can be oriented such that they do not run parallel to central axis 13, but instead, given a projection onto a common plane, form an angle with this plane. Blades 9 here in the feed direction indicated by arrow 27 are inclined to the left, with the result that swarf moving into a flow channel 19 when working the wall of a drilled hole is thus forced in the feed direction. This arrangement of blades 9 thus facilitates the removal of swarf from the active cutting edges.

Blades 9 are preferably all of identical design. Their end faces 31 protrude, as viewed in the direction of central axis 13, beyond end face 5 of reamer 1, specifically also beyond the inner region of end face 5, relative to which central axis 13 is perpendicular and surrounds bevel 29.

As in the conventional approach, all blades 9 in a feed direction indicated by arrow 27, have primary cutting edges 33, as well as adjoining secondary cutting edges 35 that slope away opposite the feed direction, however, to a significantly smaller degree than primary cutting edge 33. In the direction of rotation indicated by arrow 25, a flank 37 trails primary cutting edge 33 and secondary cutting edge 35, the flank sloping away against the direction of rotation—as viewed from the cutting edges. The flank here is preferably, however, in the form of a circular grinding chamfer at which associated blade 9 rests against the inner surface of a worked drilled hole. This produces very effective guidance of reamer 1 in the drilled hole to be worked without the need to provide guide strips or the like.

If a blade 9 is viewed from end face 5, the result is thus a first region sloping down in the feed direction, which region forms primary cutting edge 33. Following this is secondary cutting edge 35 that slopes down in the opposite direction. In the region of secondary cutting edge 35, swarf is still being removed from the wall of the drilled hole. What is found in a region adjoining this is a support region in which reamer 1 is supported against the wall of the drilled hole, or its inner surface.

The distance of outlet orifices 15 from end face 5 is thus selected such that the coolant/lubricant exiting from outlet orifices 15 hits both primary cutting edge 33 and also secondary cutting edge 35, but preferably also the region of the blades in which these still rest by their flanks 37 against the inner surface of the drilled hole. This ensures that all regions of blades 9, which are stressed during the working of a drilled hole wall both by cutting forces and also supporting forces, are cooled and lubricated.

It is not an absolute necessity here that all outlet orifices 15 terminate in peripheral face 7 of main body 3 of a reamer at the same distance from end face 5. In order to avoid excessively weakening main body 3, outlet orifices 15 can be disposed along two imaginary circles of peripheral face 7 that are at different distances from end face 5. What is preferably ensured here, as was already mentioned, is that the distance of all outlet orifices 15 from end face 5 is selected so that those regions of flank 37 of a blade 9 are also cooled and lubricated which function to support reamer 1 against the inner surface of a drilled hole.

The rear region 39 of reamer 1 situated at a distance from end face 5 serves to attach reamer 1 to a machine tool, and adapter, an intermediate piece, or the like. The outer contour of this region 39 is matched to the given means of attachment. The region here is of cylindrical form, by way of example.

Also revealed in FIG. 1 is the fact that blades 9—as viewed in the feed direction—protrude beyond end face 5; as a result, the coolant/lubricant flow is guided laterally as far as possible in the feed direction through flow channel 19. This results in very effective cooling and lubrication of the front-most regions of blades 9.

FIG. 2 illustrates reamer 1 without blades 9, in somewhat enlarged form. Identical parts are provided with identical reference numerals, and with this in mind reference is made to the description for FIG. 1.

Grooves 11 are clearly evident due to the fact that the blades have been omitted. It its also evident that they each intersect a channel 17 of the internal coolant/lubricant supply. This means that the cross-section of a channel 17 is reduced in the region of an outlet orifice 15 due to the fact that a blade 9 is inserted in groove 11. In other words, with blade 9 inserted, the cross-section of an outlet orifice 15 is smaller than the cross-section of channel 17 through which the coolant/lubricant is delivered which then exits from outlet orifice 15 through circumferential surface 7 into flow channel 19. This results in an increase in the flow rate for the coolant/lubricant within flow channel 19. This increased flow rate is maintained up to end face 5 or associated bevel 29. The coolant/lubricant flowing at an increased flow rate through flow channel 19 very effectively cools and lubricates reamer 1, and removes the swarf removed from the active cutting edges of blade 9 especially effectively. Due to the fact that the region between outlet orifice 15 and end face 5 of peripheral face 7 of reamer 1 is intact, the increased flow rate is maintained up to end face 5.

As was mentioned above, at least one of flow channels 19 can taper down towards end face 5, thereby increasingly raising the flow rate of the coolant/lubricant so as to enhance the removal of heat and to improve the diversion of swarf from the active cutting edges of blade 9.

Another effect is provided: Due to the fact that groove 11 intersects channel 17, the coolant/lubricant flows directly along a blade 9 inserted into associated groove 11, and specifically from the base B of groove 11 up to peripheral face 7 of reamer 1, with the result that blade 9 is cooled especially effectively. The heat introduced into blade 9 when a drilled hole is worked is thus dissipated in an optimum manner. The cooling or lubrication can also be promoted by providing flow guide means on peripheral face 7 in the region between outlet orifice 15, and end face 5 or bevel 29, which means guide the coolant/lubricant towards blade 9, at the lateral surface 23 of which the coolant flows from channel 17 to outlet orifice 15.

An especially high flow rate for the coolant/lubricant is produced when, as is preferred, the cross-section of flow channel 19 is smaller in the region between outlet orifice 15 and end face 9 or bevel 29 than the area of outlet orifice 15 in peripheral face 7.

In order to guide the coolant/lubricant especially effectively to end face 5, channels 17 are preferably designed in oblique form, where their central axes are inclined in the direction of end face 5 at least in the region of outlet orifice 15, with the result that the coolant/lubricant exits outlet orifices 15 from peripheral face 7 essentially in the feed direction.

In order to prevent any reverse flow by the coolant/lubricant, the cross-section of flow channel 19 can be reduced, as viewed opposite the feed direction, behind the outlet orifices 15, that is, in the region that is situated at a greater distance from end face 5 than outlet orifice 15. This can be accomplished by an inclined area or step on the peripheral face 7 of reamer 1. Provision is also made in this case whereby, when the peripheral face 7 of reamer 1 is worked, the region between end face 5 and outlet orifice 15 of peripheral face 7 is of a first outer diameter, while the region behind outlet orifices 15 is of a second outside diameter that is larger than the outer diameter in the first region close to end face 5. This produces an increase in the flow resistance for the coolant/lubricant such that this preferably flows towards end face 5 or in the feed direction.

FIG. 2 furthermore shows that the length of grooves 11 is considerably greater than their width. Blades 9 inserted into grooves 11 are thus held along an extensive region of main body 3 of reamer 1, thereby allowing forces acting on blades 9 to be optimally introduced into the main body.

FIG. 3 shows reamer 1 in cross-section, where the cutting plane runs perpendicular to central axis 13 and is provided in the area of the outlet orifices 15.

It is clearly evident that eight blades are provided here which are arranged in pairs opposing each other but which are not disposed with the same circumferential spacing relative to each other. This arrangement serves to minimize vibrations and chattering by reamer 1 when drilled holes 5 are worked.

Channels 17 are evident here that are intersected by grooves, thereby forming outlet orifices 15, the area of which within peripheral face 7 is preferably smaller than the cross-sectional area of associated channels 17. Also evident in the sectional diagram is the fact that channels 17 are inclined at an angle relative to central axis 13. Due to the varying size of intersected channels 17, it is also evident that these do not all lie in one plane or along a common circumferential line so as to not excessively weaken main body 3 of reamer 1.

It is clearly evident here that a flow channel 19 is created between each two adjacent blades. For example, flow channel 19 is situated between blades 9 and 9′, which channel is delimited laterally by mutually facing lateral surfaces 21 and 23 of blades 9 and 9′. At its side facing central axis 13, flow channel 19 is delimited by a region of peripheral face 7 that lies between end face 5, not visible here, and associated outlet orifice 15.

The dimension of flow channel 19 measured radially is produced by the distance of associated peripheral face 7 from the inner surface 41 of a worked drilled hole, this surface being indicated here by a dashed line. Provision is preferably made whereby the cross-section of flow channel 19 is smaller than the area of associated outlet orifice 15. This results in a very high flow rate for the coolant/lubricant supplied through channel 17 to orifice 15.

What is also evident in FIG. 3 is that the blades are arranged at an angle relative to central axis 13. However, it is in principle also possible to orient grooves 11 and blades 9 parallel to central axis 13. In the embodiment of reamer 1 illustrated here, a force that pushes the swarf towards end face 5 is exerted on this swarf removed by the active cutting edges due to the oblique arrangement of blades 9.

Reamer 1 is preferably impinged upon by a coolant/lubricant that is under a pressure of 20 bar up to 40 bar. Due to the reduced size of outlet orifices 15 relative to channels 17, a very high flow rate is thus produced for the coolant/lubricant in flow channels 19. It is also found that the pressure within the coolant/lubricant supply is maintained at an optimal level up to flow channels 19, thereby ensuring the removal of the swarf created as the drilled hole is created. This also has the effect that the flow rate of the cooling/lubricating medium is four to eight times greater than with conventional reamers.

The design configuration described here for reamer 1, in particular, of flow channel 19, has the effect of producing very high flow-through rates for the coolant/lubricant—even when a volumetric flow is supplied in the inner coolant/lubricant system that is significantly reduced as compared with known reamers provided with swarf spaces. Trials have demonstrated that ⅙ to ¼ the volumetric flow rate required for conventional reamers is sufficient here to ensure high flow-through rates. Reamers 1 of the type described here can thus be employed with coolant/lubricant pumps for which the output is significantly reduced relative to others.

1-18. (canceled)

19. A reamer comprising:
a main body having a first end face and a peripheral face, the peripheral face including a plurality of grooves, the main body further having an inner coolant/lubricant supply including channels which intersect the peripheral face of the main body and thus form outlet orifices, the outlet orifices disposed at a distance from the end face; and
blades inserted into the grooves;
wherein a flow channel is created between each pair of adjacent blades, each flow channel delimited by a facing lateral surface of the respective pair of adjacent blades and the peripheral face of the main body, the peripheral face being intact between outlet orifices and the end face of the main body.

20. The reamer according to claim 19, wherein the channels of the coolant/lubricant supply run at an angle and are arranged such that a central axis of each channel is inclined relative to the reamer's end face at least in the region of peripheral face of the main body.

21. The reamer according to claim 19, wherein the area of the outlet orifices is larger than the cross-sectional area of the associated flow channels.

22. The reamer according to claim 19, wherein the grooves function to accommodate the blades intersect channels such that the result that the blades inserted in the grooves partially cover the channels.

23. The reamer according to claim 19, wherein at least some of the blades protrude axially beyond the end face of main body.

24. The reamer according to claim 19, wherein the end face of the main body has a circumferential bevel.

25. The reamer according to claim 19, wherein the blades have a primary cutting edge and a secondary cutting edge, and the outlet orifices are disposed at a distance from the end face of the main body, the distance—measured axially—corresponds at least to the length of the secondary cutting edges.

26. The reamer according to claim 25, wherein the distance of the outlet orifices from the end face is greater than or equal to the length—measured axially—of the secondary cutting edges plus a supporting region of the blade adjoining the secondary cutting edges.

27. The reamer according to claim 19, wherein the blades are arranged parallel to the central axis of the reamer.

28. The reamer according to claim 19, wherein the blades are arranged at an angle relative to a central axis of the reamer.

29. The reamer according to claim 28, wherein the blades are inclined relative to the central axis such that swarf is forced out of swarf spaces towards the end face when the reamer is used.

30. The reamer according to claim 19, wherein the blades protrude approximately 0.2 mm to approximately 0.5 mm beyond the peripheral face of the main body.

31. The reamer according to claim 19, wherein the blades protrude approximately 0.3 to approximately 0.4 mm beyond the peripheral face of the main body.

32. The reamer according to claim 19, wherein a cross-section of at least one flow channel tapers down towards the end face.

33. The reamer according to claim 32, wherein a radially protruding step is provided on the peripheral face of the main body.

34. The reamer according to claim 19, wherein a fit is provided between the grooves which accommodate the blades.

35. The reamer according to claim 19, wherein the blades are secured to the main body by gluing or soldering.

36. The reamer according to claim 35, wherein the blades are attached essentially only by their longitudinally running narrow sides to a base of the associated grooves.

37. The reamer according to claim 19, wherein a cross-section of a flow channel—as measured perpendicular to the central axis—is equal to or greater than the area of the associated exit area of a channel functioning to delivery coolant/lubricant.
